(19) United States
(12) Patent Application Publication
(10) Pub. No.: US 2026/0309540 A1
(43) Pub. Date: Oct. 8, 2026

(54) WEIGHING APPARATUS AND WEIGHING METHOD USING TRIAXIAL ACCELEROMETER

(71) Applicant: A&D COMPANY , LIMITED, Tokyo (JP)

(72) Inventors: Ken IHARA, Saitama (JP); Tsuyoshi MATSUDA, Saitama (JP); Yoshikazu NAGANE, Saitama (JP)

(21) Appl. No.: 18/291,140

(22) PCT Filed: Aug. 23, 2021
(86) PCT No.: PCT/JP2021/030859

§ 371 Date: Jun. 22, 2026

(51) Int. Cl. G01G 23/01; G01P 15/18

(52) U.S. Cl. CPC G01G 23/01; G01P 15/18

(57) ABSTRACT

A weighing apparatus includes a weighing pan, a weight sensor connected to the weighing pan, a triaxial accelerometer configured to detect acceleration changes in three x-, y-, and z-axis directions by setting x and y on a plane parallel to the horizontality of the weight sensor, and z in a direction perpendicular to the horizontality of the weight sensor, a storage unit configured to store reference outputs of the three axes of the triaxial accelerometer when the weight sensor is horizontal, and an arithmetic processing unit, wherein the arithmetic processing unit compares current outputs of the three axes of the triaxial accelerometer with the reference outputs, and detects a tilt when an output of x and/or y changes, and detects a change of an installation location when an output of z changes, and notifies a user of these.

### TECHNICAL FIELD

The present invention relates to a weighing apparatus and a weighing method which use a triaxial accelerometer.

### BACKGROUND ART

A balance as a weighing apparatus measures a load component Wv perpendicular to a weighing pan by a weight sensor, and obtains a mass m of an object placed on the weighing pan from an equation (1) by using a gravitational acceleration g of a location where the balance is installed.

$$\begin{matrix}[ Numerical Equation l ] & \\ m = \frac{{W}_{V}}{g} & ( 1 )\end{matrix}$$

As illustrated in FIG. 10A, in a case where a direction in which the gravitational acceleration g acts and a direction perpendicular to the weighing pan coincide with each other, a mass measured by the balance, that is, a weighed value m can be said to be a true value. On the other hand, as illustrated in FIG. 10B, in a case where a direction in which the gravitational acceleration g acts and a direction perpendicular to the weighing pan do not coincide with each other, a component Wh that cannot be detected by the balance is generated, and a weighed value m measured by the balance is smaller than a true value.

From the above-described circumstances of the balance, when the following two occur, a weighed value can be said to contain an error.
(i) The balance tilts and the load component Wv perpendicular to the weighing pan decreases.
(ii) The location where the balance is installed changes, and the gravitational acceleration g changes.

As a measure for the case (i) above, a general balance includes a level gauge (bubble level) for detecting a tilt of the balance. For example, Patent Literature 1 discloses a technique of more accurately managing the horizontality of the balance by detecting a bubble of the level by optical sensors.

### CITATION LIST

### Patent Literature

Patent Literature 1: Japanese Published Unexamined Patent Application No. 2016-038377

### SUMMARY OF INVENTION

### Technical Problems

For the case (i) above, although a technique as disclosed in Patent Literature 1 is available, a plurality of optical sensors need to be provided around the bubble, and this makes the configuration complicated.

For the case (ii) above, users are asked to adjust the sensitivity by using a weight when the installation location of the balance is changed, however, this response depends on the users, and such adjustment may not be made in some cases.

In dealing with these problems, the inventors considered that the balance itself could detect the problems of (i) and (ii) above by detecting accelerations in three-axis directions of the balance and solve the problems.

The present invention was made based on the conventional problems and the knowledge of the inventors described above, and an object thereof is to provide a weighing apparatus and a weighing method which automatically detect acceleration changes in three-axis directions by using a triaxial accelerometer, and automatically solve problems caused by the changes.

### Solution to Problem

In order to solve the problems described above, a weighing apparatus according to an aspect of the present invention includes a weighing pan, a weight sensor connected to the weighing pan, a triaxial accelerometer configured to detect acceleration changes in three x-, y-, and z-axis directions by setting x and y on a plane parallel to the horizontality of the weight sensor, and z in a direction perpendicular to the horizontality of the weight sensor, a storage unit configured to store reference outputs of the three axes of the triaxial accelerometer when the weight sensor is horizontal, and an arithmetic processing unit, wherein the arithmetic processing unit compares current outputs of the three axes of the triaxial accelerometer with the reference outputs, and detects a tilt when an output of x and/or y changes, and detects a change of an installation location when an output of z changes, and notifies a user of these.

In the aspect described above, it is also preferable that, in a case where an output of x and/or y of the triaxial accelerometer changes, the arithmetic processing unit corrects a weighed value m detected by the weight sensor to a corrected weighed value m′ by using an equation (14).

In the aspect described above, it is also preferable that, in a case where only an output of z of the triaxial accelerometer changes, the arithmetic processing unit calculates a corrected weighed value m′ by changing the value of a gravitational acceleration to be used for calculation of a weighed value m that is detected by the weight sensor to a local gravitational acceleration value g local obtained by using an output of the z axis of the triaxial accelerometer.

In the aspect described above, it is also preferable that, when outputs of z and x and/or y of the triaxial accelerometer change, the arithmetic processing unit corrects a weighed value m detected by the weight sensor to a corrected weighed value m′ by changing the value of a gravitational acceleration to be used in the equation (14) to a local gravitational acceleration g local obtained by using outputs of the three axes of the triaxial accelerometer.

In the aspect described above, it is also preferable that, when the corrected weighed value m′ of a weighing object exceeds an acceptable threshold range with respect to a reference mass of the weighing object, the arithmetic processing unit judges that it is impossible to completely eliminate an error by correction and issues a warning to a user.

In order to solve the problems described above, a weighing method according to an aspect of the present invention includes, by using a weighing apparatus including a weighing pan, a weight sensor connected to the weighing pan, and a triaxial accelerometer configured to detect acceleration changes in three x-, y-, and z-axis directions by setting x and y on a plane parallel to the horizontality of the weight sensor, and z in a direction perpendicular to the horizontality of the weight sensor, a step (A) of acquiring current outputs of the three axes of the triaxial accelerometer, a step (B) of comparing the current outputs with reference outputs of the three axes when the weight sensor is horizontal, a step (C) of notifying a user that the apparatus has a tilt when a change in output of x and/or y is found in the step (B), and a step (D) of notifying a user that an installation location has changed when a change in output of z is found in the step (B).

In the aspect described above, it is also preferable that the weighing method includes a step (E) of correcting a weighed value m detected by the weight sensor to a corrected weighed value m′ by using an equation (14) when a change in output of x and/or y is found in the step (B), a step (F) of calculating a corrected weighed value m′ by changing the value of a gravitational acceleration to be used for calculation of a weighed value m that is detected by the weight sensor to a local gravitational acceleration value g local obtained by using an output of the z axis of the triaxial accelerometer when a change in output of only z is found in the step (B), and a step (G) of correcting a weighed value m detected by the weight sensor to a corrected weighed value m′ by changing the value of a gravitational acceleration to be used in the equation (14) to a local gravitational acceleration g local obtained by using outputs of the three axes of the triaxial accelerometer when changes in output of z and x and/or y are found in the step (B).

In the aspect described above, it is also preferable that the weighing method includes a step (H) of weighing a weighing object, and when the corrected weighed value m′ of the weighing object exceeds an acceptable threshold range with respect to a reference mass of the weighing object, judging that it is impossible to completely eliminate an error by correction and issuing a warning to a user.

### Effect of Invention

The present invention provides a weighing apparatus and a weighing method which automatically detect acceleration changes in three-axis directions and automatically solve problems caused by the changes.

### BRIEF DESCRIPTION OF DRAWINGS

FIG. 1 is a diagram illustrating a relationship among components of a triaxial accelerometer.

FIG. 2 is a diagram illustrating results of correction using the triaxial accelerometer.

FIG. 3 is a configuration block diagram of a weighing apparatus according to a first embodiment of the present invention.

FIG. 4 is a schematic perspective view of the same weighing apparatus.

FIG. 5 is a flowchart of a weighing method using the same weighing apparatus.

FIG. 6 is a configuration block diagram of a weighing apparatus according to a second embodiment of the present invention.

FIG. 7 is a flowchart of a weighing method using the same weighing apparatus.

FIG. 8 is a view illustrating a preferred attachment form of the accelerometer in the embodiments.

FIG. 9 is a view illustrating a preferred attachment form of the accelerometer in the embodiments.

FIGS. 10A and 10B are views illustrating considerations on a weighed value of a balance.

### DESCRIPTION OF EMBODIMENTS

First, consideration of the inventors until conceiving of preferred embodiments of the present invention will be described based on the drawings.

### 1. Consideration by Inventors

### 1-1. Problems of Balance

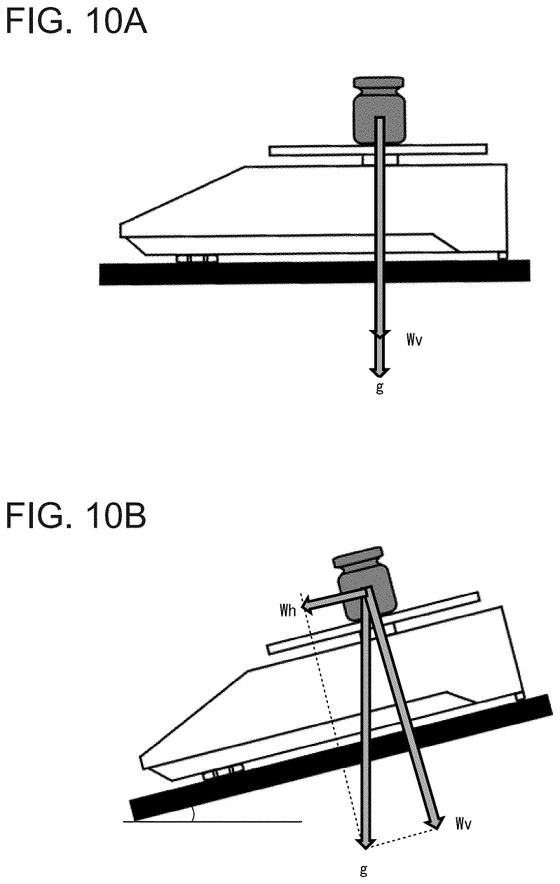

As described above with reference to FIGS. 10A and 10B, generally, a balance includes a weighing pan and a weight sensor connected to the weighing pan, and measures a load component Wv perpendicular to the weighing pan, and obtains a mass m (weighed value) of a weighing object from an equation (1) by using a gravitational acceleration g of a location where the balance is installed.

$$\begin{matrix}[ Numerical Equation l ] & \\ m = \frac{{W}_{V}}{g} & ( 1 )\end{matrix}$$

Therefore, when the following two occur, the weighed value m measured with the balance contains an error.
(i) The balance tilts and the load component Wv perpendicular to the weighing pan decreases.
(ii) The installation location of the balance is changed, and the gravitational acceleration g changes.

### 1-2. Problem-Solving Consideration

In dealing with this problem, the inventors considered that a tilt of the balance and a gravitational acceleration could be detected by equipping a triaxial accelerometer in the balance, and therefore, first, the balance could automatically detect both of (i) and (ii) above. Second, the inventors considered that the balance could identify a change in weighed value derived from a decrease in load component Wv perpendicular to the weighing pan and a change in gravitational acceleration g, and then automatically correct the change.

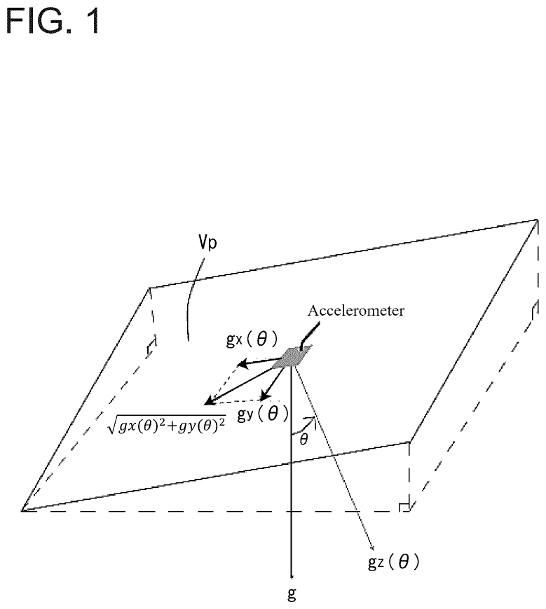

FIG. 1 is a diagram illustrating a relationship among a tilt angle and components of a gravitational acceleration when a triaxial accelerometer is provided on a certain virtual plane vp. This triaxial accelerometer (hereinafter, referred to as accelerometer) detects accelerations in orthogonal three-axis directions of the virtual plane vp. x and y of the accelerometer are on the virtual plane vp, and z is in a direction perpendicular to the virtual plane vp. Components of the gravitational acceleration g with respect to this accelerometer are respectively represented as “gx, gy, gz.” The gx and gy components are on the virtual plane vp, and the gz component is in the direction perpendicular to the virtual plane vp. The tilt angle θ is an angle between the direction of the gravitational acceleration g and the direction of the gz component.

Components to be output by the accelerometer at the tilt angle θ are respectively defined as “Xout (θ), Yout (θ), Zout (θ).” When the gravitational acceleration g detected by the accelerometer is g={gx (θ), gy (θ), gz (θ)}, gx (θ), gy (θ), and gz (θ) can be respectively expressed by equations (2), (3), and (4) by using outputs “Xout (0), Yout (0), Zout (0)” when the tilt angle θ=0. Here, Ax, Ay, and Az are proportionality coefficients, and g=|g|.

$$\begin{matrix}[ Numerical Equation 2 ] & \\ \frac{{g}_{x} ( θ )}{g} = \frac{{X}_{out} ( θ ) - {X}_{out} ( 0 )}{{A}_{x}} & ( 2 )\end{matrix}$$

$$\begin{matrix}[ Numerical Equation 3 ] & \\ \frac{{g}_{y} ( θ )}{g} = \frac{{Y}_{out} ( θ ) - {Y}_{out} ( 0 )}{{A}_{y}} & ( 3 )\end{matrix}$$

$$\begin{matrix}[ Numerical Equation 4 ] & \\ \frac{{g}_{z} ( θ )}{g} = 1 - \frac{{Z}_{out} ( θ ) - {Z}_{out} ( 0 )}{{A}_{z}} & ( 4 )\end{matrix}$$

With reference to FIG. 1, the relationship between the tilt angle θ of the accelerometer and the gravitational acceleration g is expressed as follows:

$$\begin{matrix}[ Numerical Equation 5 ] & \\ sin ( θ ) = \sqrt{{( \frac{{g}_{x} ( θ )}{g} )}^{2} + {( \frac{{g}_{y} ( θ )}{g} )}^{2}} & ( 5 )\end{matrix}$$

$$\begin{matrix}[ Numerical Equation 6 ] & \\ cos ( θ ) = \frac{{g}_{z} ( θ )}{g} & ( 6 )\end{matrix}$$

### 1-3. Correction According to Tilt of Balance

Correction of a weighed value according to a tilt of the balance, that is, a decrease in load component Wv perpendicular to the weighing pan, will be considered. A tilt of the balance can be detected by monitoring outputs of x and y of the accelerometer. A mass of a weighing object when the tilt angle θ of the balance=0 is m(0), and a mass of the weighing object when the tilt angle is θ is m(θ). A load on the weighing pan of the balance is represented as W, and a load component perpendicular to the weighing pan is represented as Wv. Here, in a case where the virtual plane vp described above is set to be parallel to the horizontality of the weight sensor, when the tilt angle θ=0, W=m(0), and the gravitational acceleration g=Wv, so that the relationship expressed by the equation (7) is established.

$$\begin{matrix}[ Numerical Equation 7 ] & \\ m ( 0 ) = \frac{{W}_{V}}{g} = \frac{W}{g} & ( 7 )\end{matrix}$$

However, when the tilt angle θ≠0, from the equation (6), the gravitational acceleration gz (θ) perpendicular to the weighing pan satisfies the equation (8), so that the load component Wv perpendicular to the weighing pan satisfies the equation (9).

$$\begin{matrix}[ Numerical Equation 8 ] & \\ {g}_{z} ( θ ) = g cos θ & ( 8 )\end{matrix}$$

$$\begin{matrix}[ Numerical Equation 9 ] & \\ {W}_{V} = W cos θ & ( 9 )\end{matrix}$$

From these, equation transformations to equations (10) to (13) are established.

$$\begin{matrix}[ Numerical Equation 10 ] & \\ m ( θ ) = \frac{{W}_{V}}{g} & ( 10 )\end{matrix}$$

$$\begin{matrix}[ Numerical Equation 11 ] & \\ m ( θ ) = \frac{W cos θ}{g} & ( 11 )\end{matrix}$$

$$\begin{matrix}[ Numerical Equation 12 ] & \\ m ( θ ) = m ( 0 ) cos θ & ( 12 )\end{matrix}$$

$$\begin{matrix}[ Numerical Equation 13 ] & \\ m ( θ ) = m ( 0 ) \sqrt{1 - {sin}^{2} θ} & ( 13 )\end{matrix}$$

The balance acquires a mass m(θ) as a weighed value. From the equations (12) and (13), it is understood that, when the balance has a tilt angle θ, a weighed value m(0) when the tilt angle θ=0 is multiplied by a correction term containing θ, so that the mass is underestimated. Therefore, when the balance has a tilt angle θ, in order to obtain a correct mass (weighed value), a mass m(θ) when the balance has the tilt angle θ needs to be divided by a correction term containing θ, that is, cos θ or √1−sin 2θ.

Concerning the correction term, a calculated value is theoretically the same regardless of whether the value is calculated by the equation (12) or the equation (13). However, in actuality, detection of a minute tilt of θ≈0 (0.1° or less) is assumed, so that a minute angle change cannot be detected when the cosine component of the equation (12) is used. Therefore, as a correction term, the sine component of the equation (13) is preferably used.

Therefore, when the accelerometer detects a tilt angle θ, based on the equations (13) and (15), the balance calculates a corrected weighed value m′ by correcting the weighed value m (mass m(θ)) measured with the balance by the following equation (14):

$$\begin{matrix}[ Numerical Equation 14 ] & \\ {m}^{′} = \frac{m}{\sqrt{1 - ( {( \frac{{g}_{x} ( θ )}{g} )}^{2} + {( \frac{{g}_{y} ( θ )}{g} )}^{2} )}} & ( 14 )\end{matrix}$$

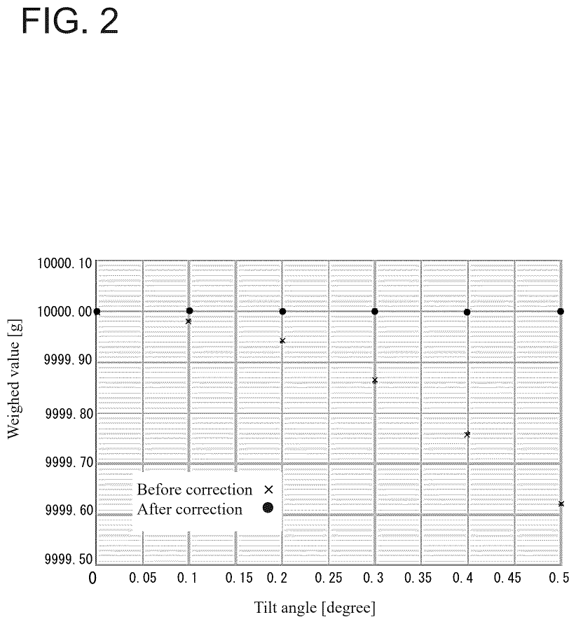

FIG. 2 is a diagram illustrating results of verification of correction using the triaxial accelerometer. In the verification, a balance with a weighing capacity of 10 kg and a minimum display of 0.01 g was used, and a weighing object placed on the weighing pan weighed 10000 g. A tilt angle from the (horizontal) installation surface of the balance was changed from 0° to 0.5°, and this tilt angle was represented as 0, and a corrected weighed value m′ was obtained by correcting a weighed value m of the weighing object by the equation (14). As illustrated in FIG. 2, at any tilt angle, 10000 g was obtained as the corrected weighed value m′.

### 1-4. Correction According to Change of Installation Location of Balance

Correction of a weighed value according to a change in gravitational acceleration g caused by a change of the installation location of the balance due to factory shipment or facility movement will be considered. A change in gravitational acceleration g can be detected by monitoring a gravitational acceleration gz (θ) in a direction perpendicular to the horizontality of the weight sensor. As described above, in the balance, a weighed value m can be obtained by the equation (1) by using a load component Wv perpendicular to the weighing pan. Therefore, by changing the value of “g” to be used in the equation (1) from a value before the movement of the balance to a value after the movement of the balance (hereinafter, referred to as a local gravitational acceleration “g local”), an error derived from the change of location where the balance is installed can be eliminated.

Here, the local gravitational acceleration g local is obtained by using an output value of the accelerometer. From the equation (6), g local is expressed by the equation (15).

$$\begin{matrix}[ Numerical Equation 15 ] & \\ glocal = \frac{{g}_{z} ( θ )}{cos θ} & ( 15 )\end{matrix}$$

When the accelerometer detects a change in gravitational acceleration g, the balance obtains a weighed value by changing the value of the gravitational acceleration g to be used for calculation of the weighed value m that is detected by the weight sensor to a local gravitational acceleration value g local obtained by using an output of the accelerometer obtained by the equation (15). Here, in this consideration, a case where the installation location of the balance is changed, that is, a case where only the z component of the accelerometer changes is considered, so that, in the equation (15), the tilt angle θ is zero, and g local=gz (θ=0). In other words, when the accelerometer detects a change in gravitational acceleration g, the balance calculates, as a corrected weighed value m′, a value obtained by dividing a load component Wv perpendicular to the weighing pan measured with the weight sensor by the local gravitational acceleration g local (θ=0) (equation (16)).

$$\begin{matrix}[ Numerical Equation 16 ] & \\ {m}^{′} = \frac{{W}_{V}}{glocal} & ( 16 )\end{matrix}$$

In the conventional technique, a local gravitational acceleration g local was obtained by (1) storing numerical values of gravitational accelerations of typical points (for example, Ibaraki: 9.79952 [m/s²], Sapporo: 9.80478 [m/s²], Osaka: 9.79703 [m/s²], etc.) in advance in the storage unit of the balance, and selecting a point closest to the installation location (local site) of the balance, or by (2) making adjustments at the installation location (local site) of the balance by using a weight. On the other hand, by utilizing the above-described consideration of using an accelerometer, a local gravitational acceleration g local of the balance obtained by using output values of the accelerometer can be reflected, and this is advantageous since the weighing accuracy is improved to be higher than in the method of the conventional technique, and when the installation location of the balance is changed, it is unnecessary to make an adjustment using a weight which had been made at the local site for each change.

1-5. Correction when Both of Tilt and Change of Installation Location of Balance Occur

Correction of a weighed value when both of a decrease in load component Wv perpendicular to the weighing pan and a change in gravitational acceleration g occur will be considered. When both of these occur, based on the considerations in 1-3 and 1-4 above, by changing the value of “g” to be used in the equation (14) concerning a tilt to a local gravitational acceleration g local, both errors can be eliminated. The g local is expressed by the equation (15), and further, equation transformation to an equation (17) is established.

$$\begin{matrix}[ Numerical Equation 17 ] & \\ glocal = \frac{{g}_{z} ( θ )}{\sqrt{1 - {sin}^{2} θ}} & ( 17 )\end{matrix}$$

A sine term of the equation (17) is obtained from the equation (5) containing gx (θ) and gy (θ) detected by the accelerometer. Therefore, a local gravitational acceleration g local is obtained by substituting output values of x, y, z of the accelerometer into the equation (17). In other words, when both of a tilt of the balance and a change in gravitational acceleration occur, the balance calculates a corrected weighed value m′ by correcting a weighed value m (mass m(θ)) measured with the balance by the equation (18) given below by using the local gravitational acceleration g local (θ≠0).

$$\begin{matrix}[ Numerical Equation 18 ] & \\ {m}^{′} = \frac{m}{\sqrt{1 - ( {( \frac{{g}_{x} ( θ )}{glocal} )}^{2} + {( \frac{{g}_{y} ( θ )}{glocal} )}^{2} )}} & ( 18 )\end{matrix}$$

### 1-6. Weighing Method Using Triaxial Accelerometer

From the consideration described above, first, the inventors considered that, by equipping a balance with a triaxial accelerometer and comparing reference outputs “Xout (0), Yout (0), Zout (0)” when the balance was horizontal (tilt angle=0) with current outputs “Xout (1), Yout (1), Zout (1),” the balance itself could detect (i) a tilt of the balance and (ii) a change derived an from installation location after distinguishing them. Further, second, the inventors were convinced that a weighed value when the balance tilted could be corrected based on the consideration in 1-3 above, a weighed value when the installation location of the balance changed could be corrected based on the consideration in 1-4 above, and a weighed value when both of the tilt and the installation location change occurred could be corrected based on the consideration in 1-5 above.

Therefore, by equipping the balance with a triaxial accelerometer and detecting the following three acceleration change patterns, the balance can automatically detect a tilt and a change of the installation location of the balance, and automatically correct an error of a weighed value derived from the changes.
Pattern (1): Only z changes.
Pattern (2): x and/or y changes (that is, x and y change, x changes, or y changes).
Pattern (3): z and x and/or y change (that is, all of x, y, and z change, x and z change, or y and z change).

When the pattern (1) occurs: The balance detects a change of the installation location, and notifies a user of this. Then, the balance corrects a weighed value by the equation (16). As a gravitational acceleration g, a local gravitational acceleration g local is used.

When the pattern (2) occurs: The balance detects a tilt, and notifies a user of this. Then, the balance corrects a weighed value by using the equation (14). As a gravitational acceleration g, a value previously used is used without change.

When the pattern (3) occurs: The balance detects changes in both of tilt and gravitational acceleration, and notifies a user of them. Then, the balance corrects a weighed value by the equation (18). As a gravitational acceleration g, a local gravitational acceleration g local is used.

Based on the considerations described above, preferred embodiments of the present invention will be described with reference to the drawings.

### 2. First Embodiment

### 2-1. Configuration of Weighing Apparatus (Balance)

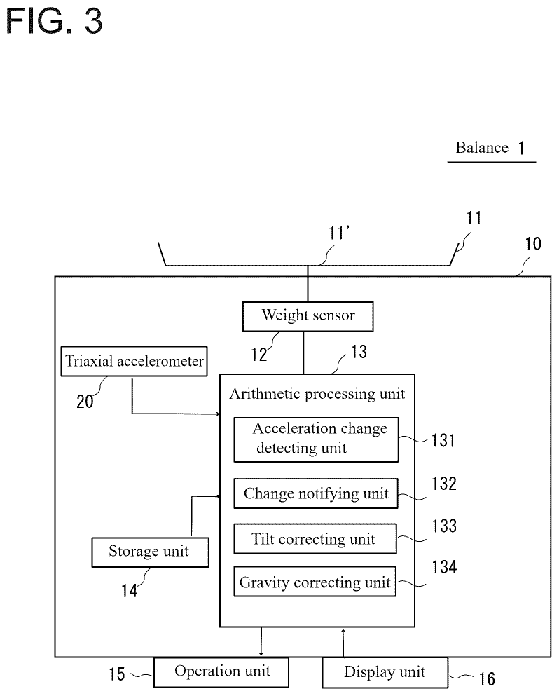

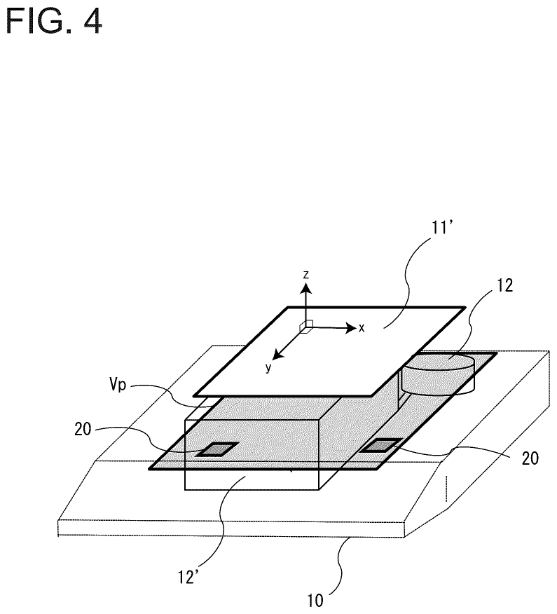

FIG. 3 is a configuration block diagram of a weighing apparatus according to a first embodiment of the present invention, and FIG. 4 is a schematic perspective view of the same weighing apparatus. The weighing apparatus is an electronic balance (hereinafter, referred to as a balance 1). The balance 1 includes a main body case 10, a weighing pan 11, a weight sensor 12, an arithmetic processing unit 13, a storage unit 14, an operation unit 15, a display unit 16, and a triaxial accelerometer 20.

As illustrated in FIG. 4, in the main body case 10, a Roberval mechanism 12′ that connects the weighing pan 11 and the weight sensor 12 is housed. The Roberval mechanism 12′ is a structure for transmitting a load applied to the weighing pan 11 to the weight sensor 12, and is a publicly known mechanism formed of a rectangular metal block and including a floating portion to be subjected to a load from the weighing pan 11, a fixed portion to be fixed to the main body case 10, upper and lower sub-beams that connect the floating portion and the fixed portion, and a load transmitting unit that transmits a load applied to the floating portion to the weight sensor 12. The weighing pan 11 is supported by the Roberval mechanism 12′, and disposed on the main body case 10. The weighing pan 11 has a horizontal surface 11′, and a weighing object is placed on the horizontal surface 11′. As the weight sensor 12, an electromagnetic balance type, a strain gauge type, a capacitance type or the like is used. A load detected by the weight sensor 12 is A/D converted and input into the arithmetic processing unit 13, and converted into a weighed value.

As described above, generally, a balance measures a load component Wv perpendicular to the weighing pan, and by using a gravitational acceleration g of a location where the balance is installed, obtains a weighed value m of a weighing object from the equation (1). For using this principle, as a premise, at the time of assembling of the balance 1, on a base held horizontally, the weight sensor 12 is attached to the main body case 10 while using, for example, a level gauge or the like so that the weight sensor 12 is kept horizontal (for example, a plane that the Roberval mechanism 12′ has is kept horizontal). The weighing pan 11 is supported from below from a direction perpendicular to the horizontality of the weight sensor 12 by a pan boss (not illustrated) projecting from the Roberval mechanism 12′, and is attached so that the horizontal surface 11′ of the weighing pan 11 coincides with the horizontality of the weight sensor.

The triaxial accelerometer 20 (hereinafter, referred to as accelerometer 20) is an IC module including a sensor that includes a spring and a weight integrated together, and an element that detects a displacement when an acceleration is applied to the sensor. The accelerometer 20 is disposed on a virtual plane vp parallel to the horizontality of the weight sensor 12, and x and y of the accelerometer 20 are disposed on the virtual plane vp, and z is disposed in a direction perpendicular to the virtual plane vp. Accordingly, the accelerometer 20 has x and y set parallel to the horizontality of the weight sensor 12, and z set in a direction perpendicular to the horizontality of the weight sensor 12, and detects accelerations in orthogonal three-axis directions (x, y, z) of the virtual plane vp. That is, the accelerometer 20 is attached so that the horizontality of the accelerometer 20 coincides with the horizontality of the weight sensor 12. The present embodiment is intended to detect and correct a change caused by a tilt of a load applied to the weight sensor 12, so that, by attaching the accelerometer 20 so that the horizontality of the accelerometer 20 coincides with the horizontality of the weight sensor 12, origins of their tilt angles coincide with each other, and an error can be reduced. The virtual plane vp on which the accelerometer 20 is disposed may be set at an arbitrary position inside the main body case 10 as long as the position does not interfere with the weight sensor 12. Preferred setting of the virtual plane vp on which the accelerometer 20 is equipped, that is, an attachment position of the accelerometer 20 will be described later. Settings of the x axis and the y axis in FIG. 4 may be reversed.

After the accelerometer 20 is attached to the balance 1, before factory shipment of the balance 1, reference outputs “Xout (0), Yout (0), Zout (0)” of the respective components are measured on a base held horizontally, that is, in a state where the weight sensor 12 is horizontal, and are stored in the storage unit 14 described later.

The operation unit 15 and the display unit 16 are provided on a front side surface of the main body case 10 of the balance 1. From the operation unit 15, weighing operations described later can be performed. On the display unit 16, a screen accompanying weighing described later is displayed.

The arithmetic processing unit 13 is a microcontroller configured by mounting, for example, a CPU, a ROM, and a RAM, etc., on an integrated circuit. The arithmetic processing unit 13 includes an acceleration change detecting unit 131 and a change notifying unit 132 for detection of an acceleration change by using the accelerometer 20. In addition, the arithmetic processing unit 13 includes a tilt correcting unit 133 and a gravity correcting unit 134 for performing corrections according to an acceleration change. Functions of the functional units 131, 132, 133, and 134 are realized by, for example, reading and executing a program stored in the storage unit 14 by the CPU. Details of the functions of the respective functional units will be described in “2-2. Weighing Method” described later.

The storage unit 14 is a semiconductor memory device such as a RAM or a flash memory, or a storage medium such as a memory card. In the storage unit 14, various programs for arithmetic operations of the arithmetic processing unit 13 are stored. Further, the storage unit 14 stores the reference outputs “Xout (0), Yout (0), Zout (0)” of the accelerometer 20 for detection of a change by using the accelerometer 20.

The configuration of the balance 1 using the accelerometer 20, according to the first embodiment, is as described above. Next, a weighing method by this balance 1 will be described.

### 2-2. Weighing Method

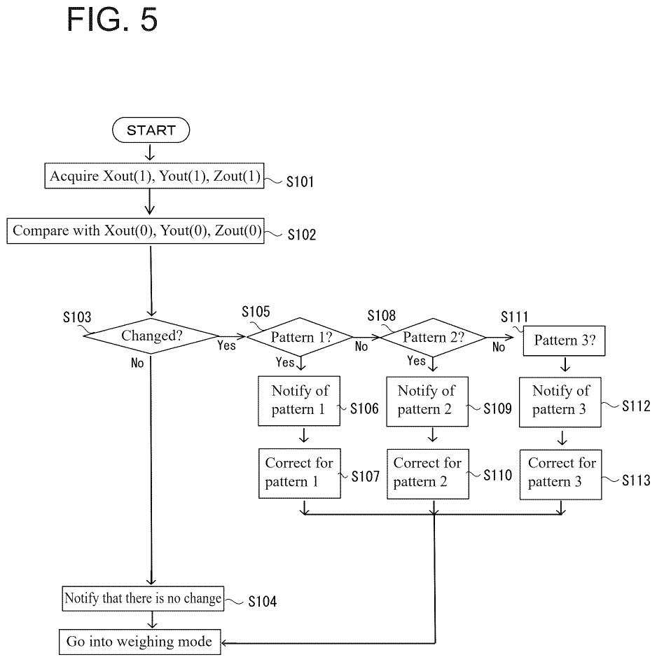

FIG. 5 is a flowchart of a weighing method using the weighing apparatus according to the first embodiment. This flow is automatically started before the balance 1 goes into a weighing mode when the power supply of the balance 1 is turned on or when the balance 1 is unused for a certain period of time.

When the flow is started, first, in Step S101, the acceleration change detecting unit 131 functions and acquires current outputs “Xout (1), Yout (1), Zout (1)” of the accelerometer 20.

Next, the flow goes to Step S102, and the acceleration change detecting unit 131 reads reference outputs “Xout (0), Yout (0), Zout (0)” and compares these with the current outputs “Xout (1), Yout (1), Zout (1).”

Next, the flow goes to Step S103, and the acceleration change detecting unit 131 judges which of the following patterns the change falls into.
Pattern (1): Only z changes.
Pattern (2): x and/or y changes.
Pattern (3): z and x and/or y change.

When none of changes falling into the patterns (1) to (3) occur, the flow goes to Step S104, and the change notifying unit 132 functions and notifies a user that there is no change in acceleration. The change notifying unit 132 displays a message that there is no change in acceleration, or specifically, there are no abnormalities in tilt and gravitational acceleration of the balance on, for example, the display unit 16. When the notification by the change notifying unit 132 is completed, the balance 1 goes into the weighing mode.

On the other hand, when the pattern (1) is detected in Step S103, the flow goes to Step S105 and Step S106. In Step S106, the change notifying unit 132 notifies the user that a change falling into the pattern (1) has occurred. The change notifying unit 132 displays a message that there is a change in acceleration in the z direction, or specifically, a change of the installation location affects a weighed value on, for example, the display unit 16.

Next, the flow goes to Step S107, and the gravity correcting unit 134 functions. The gravity correcting unit 134 makes a setting to obtain a weighed value by the equation (16) by obtaining a local gravitational acceleration g local by applying the current outputs “Xout (1), Yout (1), Zout (1)” of the accelerometer 20 to the equation (15). When setting for correction by the gravity correcting unit 134 is completed, the balance 1 goes into the weighing mode. At this time, it is also preferable that the gravity correcting unit 134 notifies the user that correction according to the change of the installation location (change in acceleration in the z direction) has been set. In subsequent weighing, the balance 1 regards a corrected weighed value m′ obtained by the equation (16) as a true value, displays the corrected weighed value m′ on the display unit 16, and records the value in the storage unit 14 or a designated storage device.

When the pattern (2) is detected in Step S103, the flow goes to Step S108 and Step S109. In Step S109, the change notifying unit 132 notifies the user that a change falling into the pattern (2) has occurred. The change notifying unit 132 displays a message that there is a change in acceleration in the x and/or y direction, or specifically, a tilt of the balance affects a weighed value on, for example, the display unit 16.

Next, the flow goes to Step S110, and the tilt correcting unit 133 functions. The tilt correcting unit 133 makes a setting to correct a weighed value by the equation (14). As setting for correction by the tilt correcting unit 133 is completed, the balance 1 goes into the weighing mode. At this time, it is also preferable that the tilt correcting unit 133 notifies the user that correction according to the tilt of the balance (change in acceleration in the x and/or y direction) has been set. Then, in subsequent weighing, the balance 1 regards a corrected weighed value m′ corrected by the equation (14) as a true value, displays the corrected weighed value m′ on the display unit 16, and records the value in the storage unit 14 or a designated external storage device.

When the pattern (3) is detected in Step S103, the flow goes to Step S111 and Step S112. In Step S112, the change notifying unit 132 notifies the user that a change falling into the pattern (3) has occurred. The change notifying unit 132 displays a message that there are changes in acceleration in the x and/or y, and z directions, or specifically, a tilt and a change of the installation location of the balance affect a weighed value on, for example, the display unit 16.

Next, the flow goes to Step S113, and both of the gravity correcting unit 134 and the tilt correcting unit 133 function. First, the gravity correcting unit 134 functions and obtains a local gravitational acceleration g local from the current outputs “Xout (1), Yout (1), Zout (1)” of the accelerometer 20 by using the equation (17). Next, the tilt correcting unit 133 functions, and makes a setting to obtain a weighed value by the equation (18) obtained by applying the local gravitational acceleration g local to the equation (14). As this setting is completed, the balance 1 goes into the weighing mode. At this time, it is also preferable that the tilt correcting unit 133 and the gravity correcting unit 134 notify the user that correction according to both of the tilt and the change of installation location of the balance (changes in acceleration in the x and/or y, and z directions) has been set. In subsequent weighing, the balance 1 obtains a corrected weighed value m′ by using the equation (18), displays the corrected weighed value m′ on the display unit 16, and records the value in the storage unit 14 or a designated external storage device.

### 2-3. Effects

As above, according to the balance 1 of the present embodiment, since the balance 1 is equipped with the triaxial accelerometer 20, both of the following problems can be detected by the balance 1:
(i) The balance tilts and the load component Wv perpendicular to the weighing pan decreases.
(ii) The location where the balance is installed is changed, and the gravitational acceleration g changes.

In particular, by simultaneously monitoring changes in output of x, y, and z by the triaxial accelerometer 20, which of the problems (i) and (ii) described above an error is derived from can be identified, and a weighed value can be properly corrected according to each problem.

For the case (i) described above, the triaxial accelerometer 20 only has to be attached, so that the configuration does not become complicated. For the case (ii), although a response to a change of the installation location had been left to the user, it becomes possible for the balance itself to detect the change and automatically make correction.

### 3. Second Embodiment

In a second embodiment, the weighing method in the first embodiment is combined with a daily check. Elements described in the first embodiment are provided with the same reference signs, and description thereof is omitted.

### 3-1. Configuration of Weighing Apparatus (Balance)

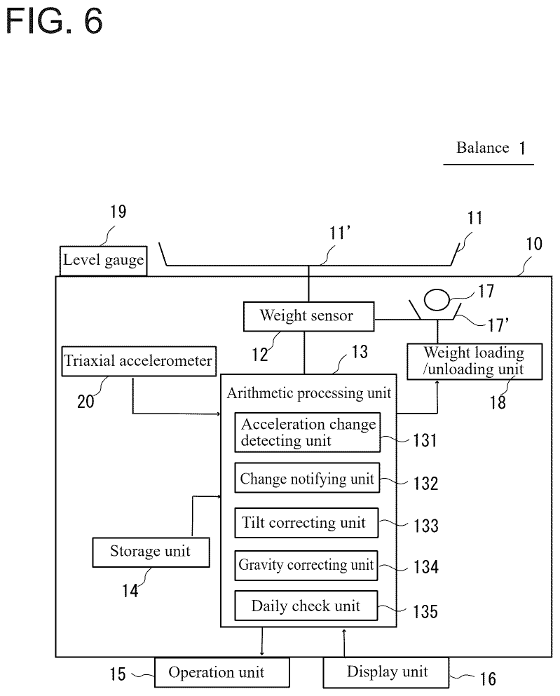

FIG. 6 is a configuration block diagram of a weighing apparatus according to the second embodiment of the present invention. The balance 1 includes the main body case 10, the weighing pan 11, the weight sensor 12, the arithmetic processing unit 13, the storage unit 14, the operation unit 15, the display unit 16, the triaxial accelerometer 20, and further, a built-in weight 17, a weight loading/unloading unit 18, and a level gauge 19.

The built-in weight 17 and the weight loading/unloading unit 18 are publicly known ones in a balance with an automatic calibration function. Before factory shipment of the balance 1, the built-in weight 17 is weighed in advance by installing the balance 1 on a base held horizontally, and a reference mass “mw0” is stored. The weight loading/unloading unit 18 includes a motor and a cam which are controlled by the arithmetic processing unit 13, and loads and unloads a plurality of times the built-in weight 17 on and from a weight receiving portion 17′. The weight receiving portion 17′ is linked to the above-described beam, and the load of the built-in weight 17 is transmitted to the weight sensor 12. As the weight loading/unloading unit 18, a pump type may be employed.

The level gauge 19 is a publicly known one to be used in such a way that a user checks whether a bubble is positioned at the center of reference lines. The level gauge 19 is provided on the front side surface of the main body case 10.

The arithmetic processing unit 13 includes a daily check unit 135 that executes a daily check application. In the storage unit 14, a program for executing the daily check application, the reference mass “mw0” of the built-in weight 17, and acceptable thresholds with respect to the reference mass “mw0” are stored.

### 3-2. Weighing Method

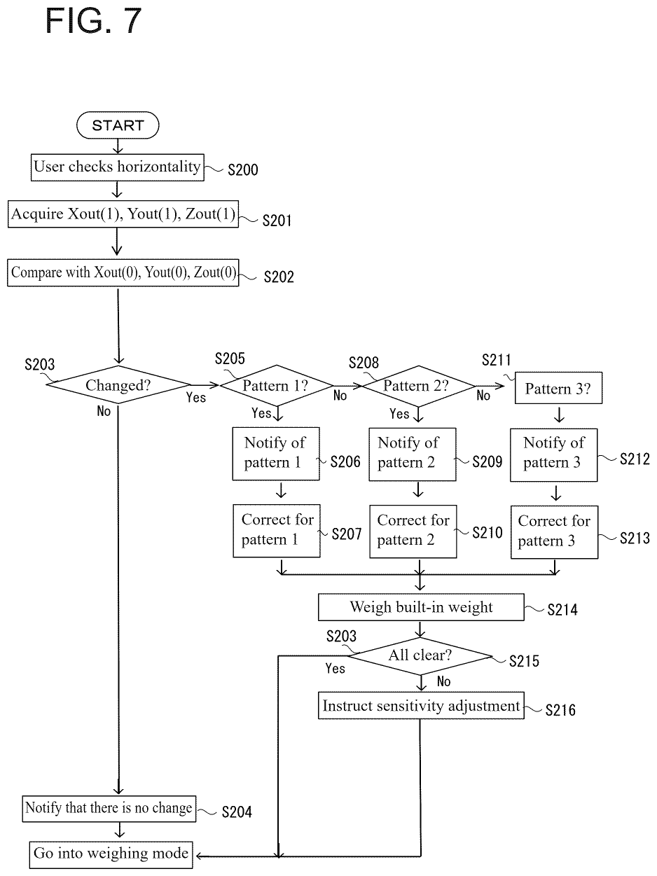

FIG. 7 is a flowchart of a weighing method using the weighing apparatus according to the second embodiment. Here, in a daily check of the balance, (1) a check of a horizontal state, (2) a check of dirt and foreign matter, (3) a check of zero return, (4) a check of reproducibility, (5) a check of corner load error, etc., are made. The balance 1 includes a “Daily Check” button on the operation unit 15, and according to the daily check application, a screen to guide checks of items (1) to (5) of the daily check is displayed on the display unit 16. The daily check application is publicly known, so that description of details thereof is omitted. In the weighing method of the present embodiment, a part of this daily check is combined with the weighing method of the first embodiment.

As the flow is started, the daily check unit 135 functions, and for the item (1): a check of a horizontal state, a screen to guide a user to check whether the bubble of the level gauge 19 is between the reference lines is displayed in Step S200. The user adjusts an adjuster (not illustrated) connected to the main body case 10 to adjust the position of the bubble. However, this operation is manual, so that a minute tilt (0.1° or less) may remain.

After the manual horizontalization in Step S200 is finished, the flow goes to Step S201. In Step S201, as in Step S101, the acceleration change detecting unit 131 acquires current outputs “Xout (1), Yout (1), Zout t (1)” of the accelerometer 20.

Subsequent Steps S202 to S213 are the same as S102 to S113 of the first embodiment. As setting for correction is completed in each of Steps S207, S210, and S213, the flow goes to Step S214.

In Step S214, the daily check unit 135 weighs the built-in weight 17 as item (4): a check of reproducibility. At this time, a corrected weighed value m′ of the built-in weight 17 is measured according to settings in Steps S207, S210, and S213.

Next, the flow goes to Step S215, and the daily check unit 135 compares the weighed value m′ of the built-in weight 17 with the reference mass mw0 and judges whether there is a problem. When an error between the weighed value m′ and the reference mass mw0 falls within the range of acceptable thresholds, the daily check unit 135 judges the all clear (YES) and the balance 1 has cleared the items (1) and (4), and after checking the remaining items, goes into the weighing mode.

On the other hand, in Step S215, when the error between the weighed value m′ and the reference mass mw0 exceeds the acceptable threshold range, the daily check unit 135 judges that there is a problem (NO) and goes to Step S216. In Step S216, the daily check unit 135 judges that the error cannot be completely eliminated by software-wise correction with respect to the resolution of the balance 1, and issues a warning to the user. The daily check unit 135 displays a warning message to urge sensitivity readjustment using an external weight on, for example, the display unit 16.

### 3-3. Effects

As above, according to the present invention, in addition to the effects of the first embodiment, by combining the daily check of the balance with a weighing method using the triaxial accelerometer 20, a minute tilt which cannot be eliminated by human operation can be effectively corrected.

In the present embodiment, for (4): a check of reproducibility, the built-in weight 17 is used as a weighing object, however, even in a balance without the built-in weight 17, the item (4) is only required to be performed by using an external weight with a known reference mass, so that the present embodiment can be carried out.

### 4. Attachment Position of Accelerometer

It is important to attach the accelerometer 20 so that the horizontality of the accelerometer 20 and the horizontality of the weight sensor 12 coincide with each other. Although the virtual plane vp on which the accelerometer 20 is disposed may be set at an arbitrary position inside the main body case 10 as long as the position does not interfere with the weight sensor 12 (Roberval mechanism 12′), and the accelerometer 20 is preferably attached by, for example, the following configuration.

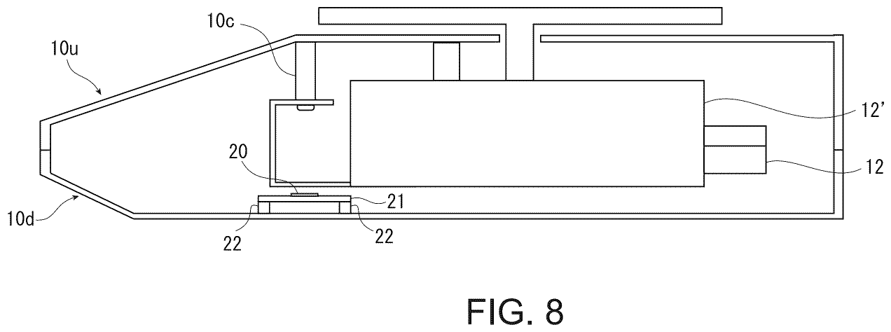

FIG. 8 is a view illustrating a preferred attachment form of the accelerometer 20 in the first and second embodiments, and illustrates an example in which the accelerometer 20 is attached to “a lower case.” FIG. 8 is a longitudinal end view of the balance 1.

The main body case 10 has a divided structure including an upper case 10u and a lower case 10d, and the upper case 10u and the lower case 10d are fitted via a sealing material such as silicon rubber. The accelerometer 20 is placed on an accelerometer installation plate 21, and for preventing wobbling of the accelerometer 20, the accelerometer 20 is fixed by, for example, screws to a case inner surface of the lower case 10d via preferably three or more attaching bosses 22. The accelerometer installation plate 21 has a flush plane, and the accelerometer installation plate 21 serves as the virtual plane vp. As the accelerometer installation plate 21, an IC board of the accelerometer 20 may be used without change.

At the time of assembling of the balance 1, the accelerometer 20 is fixed to the lower case 10d by being checked so that the accelerometer installation plate 21 is kept horizontal on a base held horizontally while using, for example, a level gauge, etc.

Here, as described above, the weight sensor 12 (Roberval mechanism 12′) is fixed to the main body case 10 via the support member 10c by being checked so that the weight sensor is kept horizontal by using a level gauge, etc., on, for example, a base held horizontally. Therefore, by attaching the accelerometer 20 horizontally to the main body case 10, the accelerometer 20 can be attached so that the horizontality of the accelerometer 20 and the horizontality of the weight sensor 12 coincide with each other.

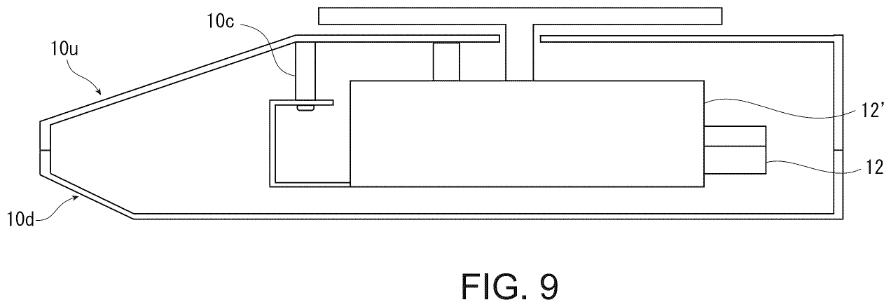

FIG. 9 is a view illustrating a preferred attachment form of the accelerometer 20 in the first and second embodiments, and illustrates an example in which the accelerometer 20 is attached to “an upper case.” In the same manner as described above, the accelerometer 20 is placed on the accelerometer installation plate 21, and fixed by screws to a case inner surface of an upper case 10u via three or more attaching bosses 22. In the same manner as described above, at the time of assembling of the balance 1, on a base held horizontally, the accelerometer 20 is fixed to the main body case 10 by being checked so that the accelerometer installation plate 21 is kept horizontal while using, for example, a level gauge, etc., and therefore, the accelerometer 20 is attached so that the horizontality of the accelerometer 20 and the horizontality of the weight sensor 12 coincide with each other.

In FIGS. 8 and 9, the weight sensor 12 is fixed to the upper case 10u, however, without limitation to this, the weight sensor 12 may be fixed to the lower case 10d. It is preferable that the fixation position of the accelerometer 20 is matched with a case to which the weight sensor 12 is fixed.

Although preferred embodiments of the present invention have been described above, the embodiments are just examples of the present invention, and these can be combined based on knowledge of a person skilled in the art, and such a combined embodiment is also included in the scope of the present invention.

### REFERENCE SIGNS LIST

1: Balance
11: Weighing pan
11′: Horizontal surface of weighing pan
12: Weight sensor
13: Arithmetic processing unit
14: Storage unit
17: Built-in weight
20: Triaxial accelerometer

1. A weighing apparatus comprising:
a weighing pan;
a weight sensor connected to the weighing pan;
a triaxial accelerometer configured to detect acceleration changes in three x-, y-, and z-axis directions by setting x and y on a plane parallel to the horizontality of the weight sensor, and z in a direction perpendicular to the horizontality of the weight sensor;
a storage unit configured to store reference outputs of the three axes of the triaxial accelerometer when the weight sensor is horizontal; and
an arithmetic processing unit, wherein
the arithmetic processing unit compares current outputs of the three axes of the triaxial accelerometer with the reference outputs, and detects a tilt when an output of x and/or y changes, and detects a change of an installation location when an output of z changes, and notifies a user of these.

2. The weighing apparatus according to claim 1, wherein
in a case where an output of x and/or y of the triaxial accelerometer changes, the arithmetic processing unit corrects a weighed value m detected by the weight sensor to a corrected weighed value m′ by using an equation (14):
$$\begin{matrix}[ Numerical Equation 14 ] & \\ {m}^{′} = \frac{m}{\sqrt{1 - ( {( \frac{{g}_{x} ( θ )}{g} )}^{2} + {( \frac{{g}_{y} ( θ )}{g} )}^{2} )}} & ( 14 )\end{matrix}$$
provided that
g: value of gravitational acceleration
θ: angle between a direction of the gravitational acceleration and z axis detected by the triaxial accelerometer
gx(θ): value of output of x detected by the triaxial accelerometer
gy(θ): value of output of y detected by the triaxial accelerometer

3. The weighing apparatus according to claim 1, wherein
in a case where only an output of z of the triaxial accelerometer changes, the arithmetic processing unit calculates a corrected weighed value m′ by changing the value of a gravitational acceleration to be used for calculation of a weighed value m that is detected by the weight sensor to a local gravitational acceleration value g local obtained by using an output of the z axis of the triaxial accelerometer.

4. The weighing apparatus according to claim 2, wherein
when outputs of z and x and/or y of the triaxial accelerometer change, the arithmetic processing unit corrects a weighed value m detected by the weight sensor to a corrected weighed value m′ by changing the value of a gravitational acceleration to be used in the equation (14) to a local gravitational acceleration g local obtained by using outputs of the three axes of the triaxial accelerometer.

5. The weighing apparatus according to claim 2, wherein
when the corrected weighed value m′ of a weighing object exceeds an acceptable threshold range with respect to a reference mass of the weighing object, the arithmetic processing unit judges that it is impossible to completely eliminate an error by correction, and issues a warning to a user.

6. A weighing method comprising:
by using a weighing apparatus including a weighing pan, a weight sensor connected to the weighing pan, and a triaxial accelerometer configured to detect acceleration changes in three x-, y-, and z-axis directions by setting x and y on a plane parallel to the horizontality of the weight sensor, and z in a direction perpendicular to the horizontality of the weight sensor,
a step (A) of acquiring current outputs of the three axes of the triaxial accelerometer;
a step (B) of comparing the current outputs with reference outputs of the three axes when the weight sensor is horizontal;
a step (C) of notifying a user that the apparatus has a tilt when a change in output of x and/or y is found in the step (B); and
a step (D) of notifying a user that an installation location has changed when a change in output of z is found in the step (B).

7. The weighing method according to claim 6, comprising:
a step (E) of correcting a weighed value m detected by the weight sensor to a corrected weighed value m′ by using an equation (14) when a change in output of x and/or y is found in the step (B);
a step (F) of calculating a corrected weighed value m′ by changing the value of a gravitational acceleration to be used for calculation of a weighed value m that is detected by the weight sensor to a local gravitational acceleration value g local obtained by using an output of the z axis of the triaxial accelerometer when a change in output of only z is found in the step (B); and
a step (G) of correcting a weighed value m detected by the weight sensor to a corrected weighed value m′ by changing the value of a gravitational acceleration to be used in the equation (14) to a local gravitational acceleration g local obtained by using outputs of the three axes of the triaxial accelerometer when changes in output of z and x and/or y are found in the step (B).

8. The weighing method according to claim 7, comprising:
a step (H) of weighing a weighing object, and when the corrected weighed value m′ of the weighing object exceeds an acceptable threshold range with respect to a reference mass of the weighing object, judging that it is impossible to completely eliminate an error by correction and issuing a warning to a user.

9. The weighing apparatus according to claim 3, wherein
when the corrected weighed value m′ of a weighing object exceeds an acceptable threshold range with respect to a reference mass of the weighing object, the arithmetic processing unit judges that it is impossible to completely eliminate an error by correction, and issues a warning to a user.

10. The weighing apparatus according to claim 4, wherein
when the corrected weighed value m′ of a weighing object exceeds an acceptable threshold range with respect to a reference mass of the weighing object, the arithmetic processing unit judges that it is impossible to completely eliminate an error by correction, and issues a warning to a user.
